(19) United States
(12) Patent Application Publication
(10) Pub. No.: US 2024/0116386 A1
(43) Pub. Date: Apr. 11, 2024

(54) UTILITY VEHICLE

(71) Applicant: Polaris Industries Inc., Medina, MN (US)

(72) Inventors: Yassin M. Kelay, Sugiez (CH); David F. Buehler, Bern (CH); Chiao George Liu, White Bear Lake, MN (US); Aaron D. Deckard, Zionsville, IN (US); Jacob Gerten, Chisago City, MN (US); Benjamin R. Bauer, Minneapolis, MN (US); Akshay A. Biyani, Minnetonka, MN (US); Naval K. Agrawal, White Bear Lake, MN (US); Kathryn L. Johnson, Glenwood City, WI (US); Austin A. Holt, St. Anthony, MN (US)

(73) Assignee: Polaris Industries Inc., Medina, MN (US)

(21) Appl. No.: 18/377,175

(22) Filed: Oct. 5, 2023

Related U.S. Application Data
(60) Provisional application No. 63/414,359, filed on Oct. 7, 2022.

(51) Int. Cl. B60L 53/62; B60L 1/00

(52) U.S. Cl. CPC B60L 53/62; B60L 1/20; B60L 2240/547

(57) ABSTRACT

Utility vehicles include ground engaging members, a frame supported by the ground engaging members, a motor supported by the frame operably coupled to the ground engaging members, and a battery configured to provide electrical power to the motor. The battery may be removable and configured to be easily charged by outside power sources such as generators and external batteries. A charger may be configured to receive instructions to charge the battery using a specific charger operating characteristic. The vehicle may also include a variety of accessory ports configured to electrically couple to accessories that use AC or DC power.

### CROSS-REFERENCE TO RELATED APPLICATIONS

The present application claims the benefit of Provisional U.S. Patent Application Ser. No. 63/414,359, filed Oct. 7, 2022, titled UTILITY VEHICLE, the entire disclosure of which is expressly incorporated herein by reference.

### FIELD OF THE DISCLOSURE

The present disclosure relates to vehicles having swappable batteries, charging methods for such batteries, and relevant vehicle architectures.

### BACKGROUND OF THE DISCLOSURE

Electric utility and recreational vehicles often face constraints not otherwise known by larger vehicles including vehicle range, weight, terrain traversed, and others. The present disclosure reflects a utility vehicle with swappable batteries, charging apparatuses and associated applications and methods of use.

### SUMMARY OF THE DISCLOSURE

In one embodiment of the present disclosure, a utility vehicle is provided. The utility vehicle comprises a pair of front ground engaging members, a pair of rear ground engaging members, and a frame supported by the ground engaging members. The utility vehicle further comprises a user interface supported by the frame, and the user interfaces is configured to receive a user input. An electric motor is supported by the frame, and a battery is removably coupled to the frame, the battery being electrically coupled to the electric motor. A charger is removably coupled to the frame and the charger is configured to be electrically coupled to the battery. An electronic controller is communicably coupled to the user interface and the charger, and a memory is storing a set of instructions. The controller is configured to operate the charger according to the first set of instructions based upon the user input at the user interface.

Additionally, the set of instructions includes a charger operating characteristic and the charger operating characteristic is one of a maximum charge rate and a charger ramp rate. Further, the charger is configured to be electrically coupled to an external power source. The controller is configured to receive a power characteristic from the external power source and the controller is further configured to alter the charger operating characteristic based on the power characteristic.

In various embodiments, the charger is configured to coupled to a generator and the generator is configured to provide an input power with an input voltage and an input frequency. The set of instructions includes a load shedding flag configured to have one of a first status and a second status and the controller is configured to monitor at least one of the input voltage and the input frequency and alter a charger operating characteristic based upon the load shedding flag having the first status and at least one of the input voltage or input frequency decreasing below a threshold.

In various embodiments, the charger is configured to couple to a generator and the generator is configured to provide an input power with an input voltage and an input frequency. The set of instructions includes a load shedding flag configured to have a first status and a second status and the controller is configured to monitor at least one of the input voltage and the input frequency. The controller is further configured to alter a charger operating characteristic based upon the load shedding flag having the first status and at least one of the input voltage or input frequency decreasing by a threshold amount.

In various embodiments, the controller is configured to receive a location of the vehicle from a location determiner and the controller is further configured to alter a charger operating characteristic based upon the location of the vehicle.

In various embodiments, the utility vehicle further comprises an accessory power supply removably coupled from the vehicle, and the accessory power supply is further configured to supply both AC power and the DC power.

In various embodiments, the utility vehicle further comprises an accessory expansion assembly separably coupled to the vehicle, and the accessory expansion assembly is electrically coupled to the battery assembly and configured to provide DC power to a plurality of accessories.

In another embodiment of the present disclosure, a recreational vehicle is provided. The recreational vehicle comprising a power pack comprising at least one ground engaging member. The power pack further comprising a power pack frame supported by the at least one ground engaging member and a motor supported by the power pack frame. The motor is configured to provide power to the at least one ground engaging member. The power pack further comprises a battery supported by the power pack frame and the battery is electrically coupled to the motor. The recreational vehicle further comprises a vehicle frame removably coupled to the power pack and a seat supported by the vehicle frame and the seat is configured to support an operator.

In various embodiments of the recreational vehicle, the power pack is a first power pack and the first power pack is positioned generally at a front of the vehicle. The recreational vehicle further comprises a second power pack positioned generally at a rear of the vehicle. The second power pack comprises a second power pack frame supported by at least one rear ground engaging member and a second motor supported by the second power pack frame. The second motor is configured to provide power to the at least one rear ground engaging member, and a second battery is supported by the second power pack frame. The second battery is electrically coupled to the second motor.

In various embodiments of the recreational vehicle, the seat is located longitudinally intermediate the first power pack and the second power pack. In various embodiments, the recreational vehicle comprises an electronic controller, and the electronic controller is electrically coupled to each of the first power pack and the second power pack. In various embodiments, the power pack comprises a third battery electrically coupled to the battery of the power pack.

In another embodiment of the present disclosure, a utility vehicle is provided. The utility vehicle comprises a plurality of ground engaging members and a frame supporting the plurality of ground engaging members. The utility vehicle also comprises an operator area supported by the frame and a seat positioned within the operator area. The utility vehicle also comprises a powertrain, the powertrain comprising a motor supported by the frame, and the motor is configured to provide power to at least one of the plurality of ground engaging members. The utility vehicle comprises a charger electrically coupled to the battery and the charger has a charging input. The charger is configured to operate with a charging characteristic and the charging input is configured to receive a power input from an external power source. The utility vehicle also comprises a controller being operable to alter the charging characteristic of the charger and a memory configured to store instructions. The instructions, when executed by the controller, causes the controller to receive a power characteristic from the external power source based upon the power input, determine an operating charging characteristic based upon the power characteristic, and operate the charger with the operating charging characteristic.

In various embodiments, the operating charging characteristic is one of a maximum charge rate and a charging ramp rate. Further, the charging ramp rate is operably in a plurality of modes. In various embodiments, the utility vehicle further comprises a user interface, and the user interface includes a screen layout configured with a first input. The first input is configured to alter a maximum charge rate and a second input configured to alter a charging ramp rate.

In another embodiment of the present disclosure, a utility vehicle is provided. The utility vehicle comprises a plurality of ground engaging members and a frame supported by the plurality of ground engaging members. An operator area is supported by the frame and a seat is positioned within the operator area and a user interface is configured with an input. The utility vehicle further comprises a powertrain, the powertrain comprising a motor supported by the frame. The motor is configured to provide power to at least one of the plurality of ground engaging members. The powertrain also comprises a battery supported by the frame and the battery is electrically coupled to the motor. A charger is electrically coupled to the battery and the charger has a charging input and is configured to operate with a charging characteristic. The charging input is configured to receive a power input from an external power source. The powertrain further comprises a controller being operable to alter the charging characteristic of the charger and a memory configured to store instructions. The instructions, when executed by the controller, cause the controller to receive a user input from the user interface, determine an operating charging characteristic based upon the user input, and operate the charger with the operating charging characteristic.

In various embodiments, the operating charging characteristic is one of a maximum charge rate and a charging ramp rate. Further, the charging ramp rate is operable in a plurality of modes. In various embodiments, the user interface further includes a screen layout configured with a first input configured to alter a maximum charge rate and a second input configured to alter a charging ramp rate.

In another embodiment of the present disclosure, a utility vehicle is provided. The utility vehicle comprises a plurality of ground engaging members and a frame is supported by the plurality of ground engaging members. The utility vehicle further comprises a powertrain configured to supply power to at least one of the plurality of ground engaging members. The powertrain comprises a motor supported by the frame and the motor is operably coupled to at least one of the plurality of ground engaging members. A battery is supported by the frame and a controller is coupled between the battery and the motor. The utility vehicle further comprises a charger removably coupled to the vehicle and the charger is electrically coupled to the battery. An accessory port is removably and electrically coupled to the battery, the accessory port is configured to electrically couple to an accessory battery. Further, the battery and the accessory battery are configured to be bidirectionally coupled.

In various embodiments, the utility vehicle further comprises a cover configured conceal at least a portion of the battery. In various embodiments, the utility vehicle also includes an external power bank configured to provide either AC power or DC power to the vehicle.

In another embodiment of the present disclosure, a battery assembly is provided. The battery assembly comprises a housing and a plurality of cells within the housing. The housing comprises a first side, a second side, a third side, and fourth side. The first side and the third side extend in a first direction and the second side and the fourth side extend in a second direction, the second direction being orthogonal to the first direction. The battery assembly further comprises a cover coupled to the top of the housing and a retention member coupled between one side extent of the cover and an opposite side extent of the cover. The retention member extends along a center of the cover in a battery width direction. A charging port is positioned on the cover, the charging port positioned on one side of the strap. The battery assembly further comprises a battery level indicator and a vent, and at least one of the battery level indicator and the bent are positioned on the cover on the other side of the strap.

In various embodiments, the battery level indicator and the vent are positioned adjacent each other. In various embodiments, the battery assembly further comprises a base coupled to each of the first side, the second side, the third side, and the fourth side. The base extends generally parallel to the cover and the fourth side includes a recessed portion extending between the cover and the base. Further, the fourth side includes a T-slot extending between the cover and the base.

In various embodiments, the charging port is configured to mate with a connector, and the connector comprises a plurality of accessory pins and a pair of primary voltage pins positioned within a pair of recesses. At least a first portion of the plurality of accessory pins are on a first side of a line extending through the pair of primary voltage pins and the remainder of the plurality of accessory pins are on a second side of the line extending through the pair of primary voltage pins. Further, the first portion of the plurality of accessory pins comprise a single ground pin. Further, the recesses of the connector comprise a generally arced circumference with at least one pointed portion, and the at least one pointed portion is positioned on the first side of the line extending through the pair of primary voltage pins.

### BRIEF DESCRIPTION OF THE DRAWINGS

FIG. 1 is a diagrammatic representation of a vehicle of the present disclosure;

FIG. 2 is a diagrammatic representation of another vehicle of the present disclosure;

FIG. 3 is a control schematic for any of the vehicles of the present disclosure;

FIG. 4 is a perspective view of a battery for any of the vehicles of the present disclosure;

FIG. 5 is a bottom perspective view of the battery of FIG. 4;

FIG. 6 is a top view of the battery of FIG. 4;

FIG. 7 is a bottom view of a connector capable of physically coupling to the battery of FIG. 4;

FIG. 7A is a perspective view of a straight connector capable of physically coupling to the battery of FIG. 4;

FIG. 8 is a perspective view of a connection port of any of the vehicles of the present disclosure;

FIG. 8A is a perspective view of a connection port of any of the vehicles of the present disclosure;

FIG. 9 is a perspective view of the connection port on the battery of FIG. 4;

FIG. 10 is an exploded view of the connector of FIG. 7 coupled with the connection port of FIG. 9;

FIG. 11 is a charger screen layout of a user interface of any of the vehicles of the present disclosure;

FIG. 12 is a chart displaying a plurality of modes of the charger of any of the vehicles of the present disclosure;

FIG. 13 is a process diagram for implementing a load shedding process on any of the vehicles of the present disclosure;

FIG. 14 is a generator selection screen layout of a user interface of any of the vehicles of the present disclosure;

FIG. 15 is a battery charging screen layout of a user interface of any of the vehicles of the present disclosure; and

FIG. 16 is a block diagram of a computing system for implement aspects of the present disclosure.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

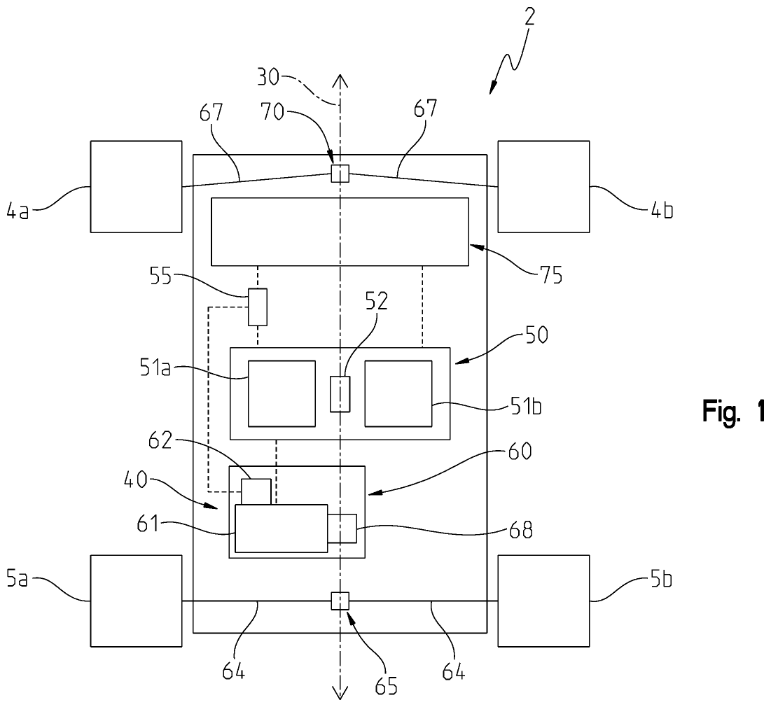

In the present disclosure, with reference to FIG. 1, a recreational or utility vehicle 2 with an electric powertrain 40 will be described. Vehicle 2 includes a frame 10 supported by a plurality of front ground engaging members 4, including a front left ground engaging member 4a and a front right ground engaging member 4b, and a plurality of rear ground engaging members 5, including a rear left ground engaging member 5a and a rear right ground engaging member 5b positioned about a longitudinal centerline 30. Ground engaging members 4a, 4b, 5a, 5b may be tires, skis, tracks, or other suitable ground engaging members configured to support frame 10. In various embodiments, vehicle 2 includes a single front ground engaging member 4 and/or a single rear ground engaging member 5 or a single ground engaging member may be provided along the right side and the left side of vehicle 2. In the present embodiment, vehicle 2 includes a pair of front ground engaging members 4a, 4b and a pair of rear ground engaging members 5a, 5b. Vehicle 2 also includes a seat (not shown) supported by frame 10 within an operator area (not shown). Vehicle 2 may also include a steering assembly (not shown) configured to steer at least one of ground engaging members 4a, 4b, 5a, 5b. In various embodiments, vehicle 2 includes an upper frame assembly (not shown) configured to surround the operator area. In some examples, a layout of vehicle 2 may be the same or similar to the vehicle layout described in U.S. Pat. No. 10,960,941, issued Mar. 30, 2021, titled “VEHICLE,” the entire disclosure of which is expressly incorporated herein by reference.

Powertrain 40 is supported by frame 10 and in the present embodiment is configured as an electric powertrain with at least one motor assembly 60 and one battery assembly 50. Motor assembly 60 includes an electric motor 61 and a motor controller 62. Electric motor 61 may be an AC Motor, a DC motor, or a brushless DC motor. In the present embodiment, vehicle 2 comprises a single electric motor 61 positioned longitudinally intermediate front ground engaging members 4a, 4b and rear ground engaging members 5a, 5b. In the present embodiment, motor 61 is positioned along longitudinal centerline 30 and rearward of battery assembly 50. Motor controller 62 is electrically coupled to motor 61 and configured to control a motor characteristic of motor 61. Motor controller 62 may be integrated into a housing (not shown) of motor 61 or may otherwise be physically separated from motor 61. In various embodiments, the motor characteristic may be a motor speed, a torque output, a motor acceleration, a current input to the motor, a voltage input to the motor, or other motor characteristic.

Battery assembly 50 is electrically coupled to motor assembly 60 by a plurality of electrical cables (not shown). Battery assembly 50 and motor assembly 60 may be placed adjacent each other to minimize the length of the electrical cables. Battery assembly 50 includes at least one vehicle battery, or traction battery 51 and a battery controller, or battery management unit (BMU) 52. Battery assembly 50 may be placed in various locations on vehicle 2. In the present embodiment, battery assembly 50 is positioned longitudinally intermediate front ground engaging members 4a, 4b and rear ground engaging members 5a, 5b. In various embodiments, battery assembly 50 is positioned laterally intermediate front ground engaging members 4a, 4b or laterally intermediate rear ground engaging members 5a, 5b. Additional disclosure regarding electric powertrain layouts can be found in U.S. application Ser. No. 17/587,721, filed Jan. 28, 2022, titled “YOUTH ELECTRIC VEHICLE”, attorney docket no. “PLR-02-29200.02P-US”, the entire disclosure of which is expressly incorporated herein by reference.

In various embodiments, battery assembly 50 includes a first battery 51a and a second battery 51b. Batteries 51a, 51b may be electrically coupled in series or in parallel depending upon desired performance characteristics of vehicle 2. In various embodiments, vehicle 2 may be configured to operate in a first mode or configuration with only first battery 51a electrically coupled to motor assembly 60 and may also be configured to operate in a second mode or configuration with only second battery 51b electrically coupled to motor assembly 60. That is, a user may have access to both batteries 51a and 51b, and when first battery 51a is fully discharged, the user or BMU 52 may switch to power supplied from battery 51b so that the user can continue to operate vehicle 2 while the fully discharged first battery 51a charges.

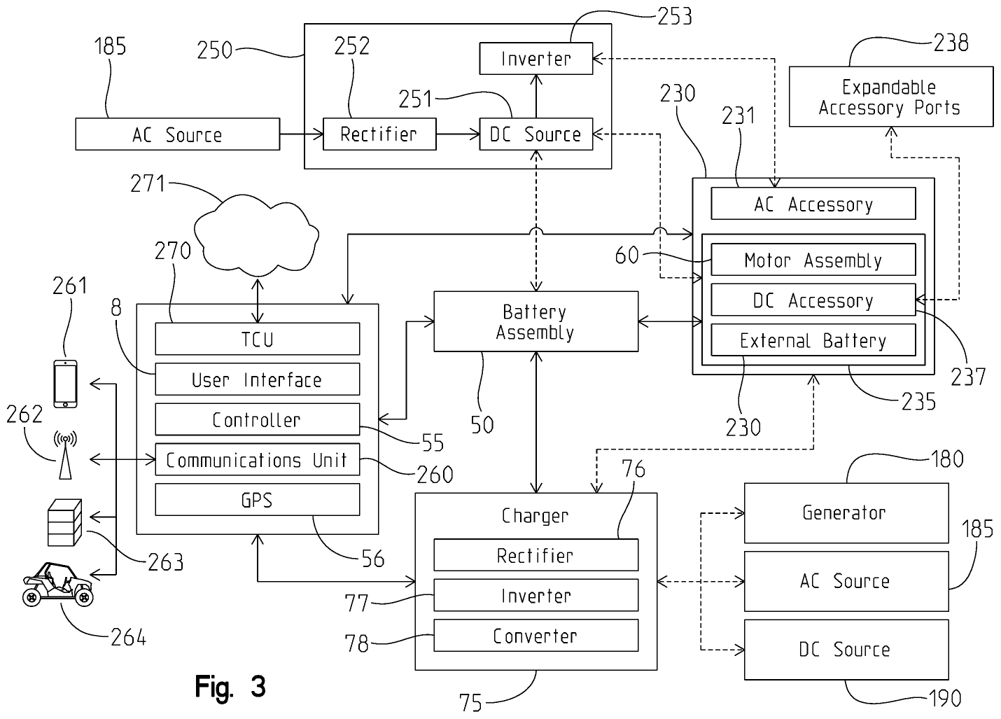

Powertrain 40 also includes a charger 75 electrically coupled to battery assembly 50. In various embodiments, charger 75 may also be coupled to a plurality of power draw components 230. As shown in FIG. 3, charger 75 includes a rectifier 76, an inverter 77, and a converter 78. In various embodiments, charger 75 may only include rectifier 76. In various embodiments, charger 75 includes rectifier 76 and inverter 77. In various embodiments, charger 75 includes rectifier 76 and converter 78. Rectifier 76 may be a half-wave or full-wave rectifier configured to rectify an AC voltage to a DC voltage to then be stored by battery assembly 50. In various embodiments, the inverter 77 may be used within charger 75 so that battery assembly 50 can invert a DC voltage stored in battery assembly 50 to an AC voltage to be used by an AC accessory 231 (FIG. 3). In various embodiments, charger 75 is configured with a converter 78 to raise or lower the voltage passing through charger 75. In various example, a DC accessory 237 is electrically coupled to charger 75 and a higher voltage from battery assembly 50 is converted by converter 78 to be used by DC accessory 237. Vehicle 2 also includes a controller 55 operably coupled to charger 75, battery assembly 50 and motor assembly 60. Controller 55 may also be coupled directly or indirectly to each of power draw components 230.

In various embodiments, battery assembly 50 includes a rectifier 76, an inverter 77, and a converter 78. Battery assembly 50 may be configured to directly provide AC voltage or DC voltage to power draw components 230. Battery assembly 50 outputs DC voltage through rectifier 76 to provide an AC voltage to AC accessory 231. Battery assembly 50 outputs a DC voltage at a first voltage level through converter 78 and provides a DC voltage at a second voltage level to various power draw components 230.

Referring again to FIG. 1, vehicle 2 includes a shiftable transmission 68, a rear drive 65 and a front drive 70. Shiftable transmission 68 is operably coupled to motor 61 and configured with a plurality of gear ratios. In various embodiments, shiftable transmission 68 has a reverse gear, a park gear, a forward high gear, and a forward low gear. In various other embodiments, shiftable transmission 68 includes a forward medium gear. In various embodiments, shiftable transmission 68 includes an electronic shift system. Additional disclosure regarding an electronic shift system can be found in U.S. Pat. No. 9,746,070, issued Aug. 29, 2017, titled “ELECTRONIC CONTROL OF A TRANSMISSION,” the entire disclosure of which is expressly incorporated herein by reference. In various embodiments, vehicle 2 does not include shiftable transmission 68 and motor 61 is directly coupled to front drive 70.

Rear drive 65 is positioned laterally intermediate rear ground engaging members 5a, 5b and is coupled to motor 61 by a rear propshaft 63. In the present embodiment, rear drive 65 includes a single input and a pair of outputs. Propshaft 63 extends between the single input and motor 61. Further, on each side of vehicle 2, a halfshaft 64 extends between one of the outputs of rear drive 65 and one of the rear ground engaging members 5a, 5b. That is, a power path is created between motor 61 and rear ground engaging members 5a, 5b by power transferred to rear propshaft 63 from electric motor 61, to rear drive 65 from rear propshaft 63, to rear halfshafts 64 from rear drive 65, and to rear ground engaging members 5a, 5b from rear halfshafts 64. Front drive 70 is positioned laterally intermediate front ground engaging members 4a, 4b and is coupled to motor 61 by a front propshaft 66. In the present embodiment, front drive 70 includes a single input and a pair of outputs. Front propshaft 66 extends between the single input and motor 61. Further, a pair of front halfshafts 67 extend between each of the outputs of front drive 70 and each of the front ground engaging members 4a, 4b. That is, a power path is created between motor 61 and front ground engaging members 4a, 4b by power transferred to front propshaft 66 from electric motor 61, to front drive 70 from front propshaft 66, to front halfshafts 67 from front drive 70, and to front ground engaging members 4a, 4b from front halfshafts 67. Rear drive 65 and front drive 70 may be open differentials, electronic locking differentials, a manually locking differential, or a limited-slip differential.

Vehicle 2 also includes a front suspension (not shown) and a rear suspension (not shown) configured to couple ground engaging members 4a, 4b, 5a, 5b to frame 10. Front suspension may be a dual A-arm suspension, a strut suspension, or another type of suspension. Rear suspension may be a dual A-arm suspension, a strut suspension, a trailing arm suspension, or another type of suspension. Additional details regarding vehicle suspension can be found in U.S. application Ser. No. 17/098,185, filed Nov. 13, 2020, titled “VEHICLE,” attorney docket no. “PLR-02-29448.02P-US,” and U.S. Pat. No. 8,613,335, issued Dec. 24, 2013, titled “SIDE-BY-SIDE VEHICLE,” the entire disclosure of which is expressly incorporated herein by reference.

### Power Packs

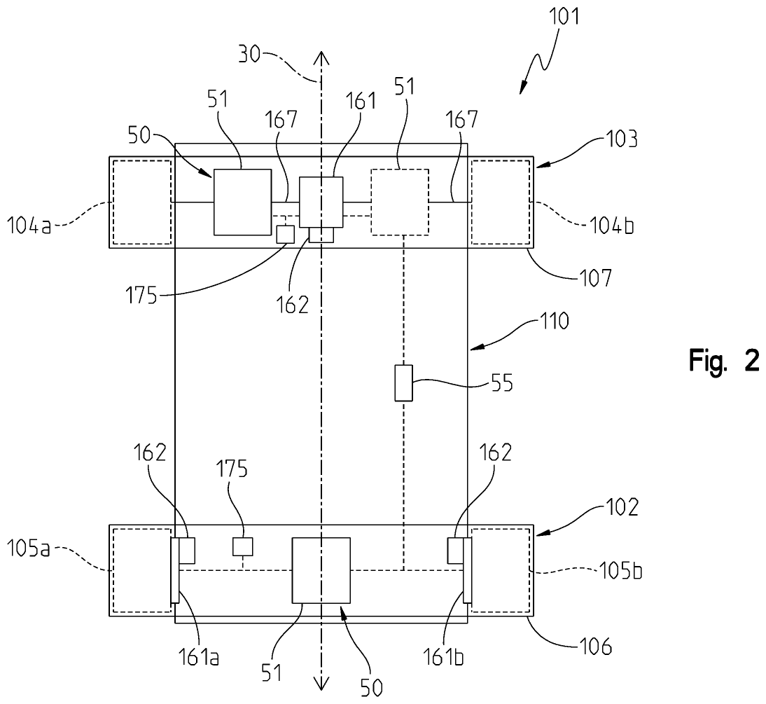

Now referring to FIG. 2, a vehicle 101 will be described. Vehicle 101 may be similarly shaped as vehicle 2 and may also operate similarly to vehicle 2. Vehicle 101 may also comprise substantially the same parts as vehicle 2, however, the parts may be rearranged and/or relocated from the orientation of vehicle.

Vehicle 101 includes a rear powerpack 102 and a front powerpack 103. Each of rear powerpack 102 and front powerpack 103 supports a frame 110. Illustratively, rear powerpack 102 includes a pair of rear ground engaging members 105, including a rear left ground engaging member 105a and a rear right ground engaging member 105b and a rear powerpack frame 106, and the rear ground engaging members 105a, 105b are configured to support a rear powerpack frame 106. Rear powerpack 102 includes battery assembly 50 supported by rear powerpack frame 106, and the battery assembly 50 is positioned laterally intermediate rear ground engaging members 105a, 105b. Further, rear powerpack 102 includes a first hub motor 161a operably coupled to rear left ground engaging member 105a and a second hub motor 161b operably coupled to rear right ground engaging member 105b. That is, rear powerpack 102 is a dual motor powerpack. In various embodiments, rear powerpack 102 only includes a first hub motor 161a and may be a single motor powerpack. In the present embodiment, first hub motor 161a is positioned adjacent the rear left ground engaging member 105a of the pair of rear ground engaging members 105 and second hub motor 161b is positioned adjacent the rear right rear ground engaging member 105b of the pair of rear ground engaging members 105. First hub motor 161a receives electrical power from battery assembly 50 and then provides power to the first rear ground engaging member 105a of the pair of rear ground engaging members 105. Second hub motor 161b receives electrical power from battery assembly 50 and provides power to the second rear ground engaging member 105b of the pair of rear ground engaging members 105. Each motor 161a, 161b is coupled to a motor controller 162 configured to control a motor characteristic of the motor 161a, 161b. In the present embodiment, rear powerpack 102 is removably coupled to frame 110. That is, rear powerpack 102 may be coupled to frame 110 through a removable clamp, fastener, splined interface, pin, latch or plurality thereof.

Front powerpack 103 includes a pair of front ground engaging members 104, including a front left ground engaging member 104a and a front right ground engaging member 104b and a front powerpack frame 107, and the front ground engaging members 104a, 104b are configured to support the front powerpack frame 107. Front powerpack 103 includes a battery assembly 50 supported by front powerpack frame 107, and the battery assembly 50 is positioned intermediate front ground engaging members 104a, 104b. Front powerpack 103 includes a motor 161 positioned along vehicle centerline 30 and is configured to provide power to each of the front ground engaging members 104a, 104b through a pair of front halfshafts 167. That is, front powerpack 103 is a single motor powerpack. In various embodiments, motor 161 of front powerpack 103 is an axial flux motor with two outputs, and each output extends to one of the pair of front ground engaging members 104a, 104b. Front powerpack 103 also includes a motor controller 162 positioned adjacent motor 161 configured to control a motor characteristic of motor 161. In the present embodiment, front powerpack 103 is removably coupled to frame 110. That is, front powerpack 103 may be coupled to frame 110 through a removable clamp, fastener, splined interface, pin, latch or plurality thereof.

In the illustrated configurations, rear powerpack 102 is a powerpack with a hub motor configuration and front powerpack 103 is a powerpack with a center motor and axle configuration. In various embodiments, vehicle 101 may include one powerpack with a hub motor configuration and one powerpack with a center motor/axle configuration, and powerpack 102 may be position at the front of vehicle 101 or the rear of vehicle 101, and powerpack 103 is positioned at the other of the front of vehicle 101 or the rear of vehicle 101. In various embodiments, vehicle 101 may include two powerpacks 102 or two powerpacks 103.

In various embodiments, each of rear powerpack 102 and front powerpack 103 includes a charger 175. Charger 175 is electrically coupled to battery 51. Powerpacks 102, 103 may be removed from vehicle 101 and charged at a location apart from vehicle 2 which may be easier to access. In various embodiments, powerpacks 102, 103 may be charged while they are coupled to vehicle 101. In various embodiments, a user may have a plurality of powerpacks 102, 103 and interchange them as desired. Powerpacks 102, 103 may be configured for different applications. In one example, one of powerpacks 102, 103 may be configured for higher torque, lower speed while the other powerpack 102, 103 may be configured for higher speed, lower torque, and a user may interchange powerpacks as desired.

Vehicle 101 also includes a controller 155 supported by frame 110. Controller 155 is positioned on vehicle 101 and is configured to communicate with each of rear powerpack 102 and front powerpack 103 to ensure consistent communication between powerpacks 102, 103. In one embodiment, if one of powerpacks 102, 103 is installed incorrectly, controller 155 may provide a fault signal to the user, or otherwise prohibit the vehicle from moving. A fault signal may include a noise, a visual notification on a user interface (similar to user interface 8 of vehicle 2) or another signal.

Referring again to FIG. 3, charger 75 is configured to receive electrical power from a generator 180, an AC source 185, or a DC source 190. In some examples, generator 180 may include the Polaris Power P3200iE Power Portable Inverter Generator available from Polaris Industries Inc., Medina, Minnesota. Generator 180 may be a generator of any suitable power generation size, including 500 Watts (W), 900 W, 1200 W, 1500 W, 2000 W, 2500 W, 3000 W, 3500 W, 4000 W, 5000 W, 6000 W or greater. Generator 180 is configured such that a power output is an AC power output or a DC power output. The AC source 185 may be a power supply from a home plug-in, an additional vehicle, or other type of AC power supply. The DC source 190 may be a battery, a converter, or other type of DC power supply.

Charger 75 is electrically coupled to battery assembly 50 and is optionally coupled to the plurality of power draw components 230. The power draw components are comprised of one or more AC drawing components 231 and one or more DC drawing components 235. AC drawing components 231 may be an accessory which utilizes AC power, such as an AC motor, a refrigerator, a compressor, lights, or other accessory. DC drawing components 235 include an external battery 236, a DC accessory 237, electric motor assembly 60, or an accessory expansion assembly 238. DC accessories 237 may include lights, portable chargers, speakers, electric power tools such as drills, saws, chain saws, augers, or other DC accessories.

### Exportable Power

Vehicle 2 may also include various ways to expand power input and power output. An exportable power bank, or external battery, 250 may be removably coupled to vehicle 2. Exportable power bank 250 includes a DC source, or DC power bank 251, such as a battery, which can be charged by AC source 185 passing electrical current through a rectifier 252 to change the AC current to a DC current before being stored in DC power bank 251. In the present embodiment, DC power bank 251 may be electrically coupled to battery assembly 50 to provide additional battery capacity to traction battery 51 (see FIG. 2). In various embodiments, DC power bank 251 may be electrically coupled to DC drawing components 235. Exportable power bank 250 may also be electrically coupled to AC accessories 231. Exportable power bank 250 includes an inverter 253 electrically coupled to the DC power bank 251 configured to alter the DC current from the DC power bank 251 to a usable AC current so that power within DC power bank 251 can be used by AC accessories 231.

In the present embodiment, exportable power bank 250 is a separable power supply configured to increase the amount of power available to vehicle 2. In one example, exportable power bank 250 is charged via a wall outlet at home or elsewhere and may be added onto vehicle 2 if a user would like to increase the power available to vehicle 2. Exportable power bank 250 may be used to increase a speed of vehicle 2, a range of vehicle 2, a max torque output of vehicle 2, or another performance characteristic of vehicle 2. Additionally, exportable power bank 250 may be used to provide power to accessories thus providing an AC power source from vehicle 2 to power AC accessories, which may otherwise not be available. In one example, exportable power bank 250 is commensurate in shape, size, and operation to battery 51.

In various embodiments, exportable power bank 250 is chargeable by vehicle 2. Battery assembly 50 may be configured to charge DC power bank 251 of exportable power bank 250 so that a user may transfer exportable power bank 250 from a first vehicle to a second, different vehicle. In various embodiments, a first vehicle 2 has a fully charged battery assembly 50 and a second vehicle 2 has a fully discharged battery assembly 50. A user may electrically couple exportable power bank 250 to the first vehicle 2 and charge exportable power bank 250, and the user may then electrically couple the charged power bank 250 to the fully discharged second vehicle 2 to charge the battery assembly 50 of second vehicle 2.

### Expandable DC Solution

DC accessory 237 may be coupled to vehicle 2 using a DC connection kit. An exemplary DC connection is The Polaris PULSE Bus Bar sold by Polaris Industries Inc., Medina Minnesota. Vehicle 2 may also comprise an accessory expansion assembly 238 which increases the number of DC accessories which can be electrically coupled to vehicle 2. In various embodiments, accessory expansion assembly 238 includes one additional accessory slot, two additional accessory slots, three additional accessory slots, four additional accessory slots, five additional accessory slots, six additional accessory slots, seven additional accessory slots, eight additional accessory slots or more additional accessory slots. Accessory expansion assembly 238 may include a DC/DC converter configured to alter the voltage level provided to each DC accessory 237. In various examples, a user may increase the total battery capacity of vehicle 2, and a user may desire to increase the number of accessories capable of being powered by battery assembly 50 of vehicle 2. The user may then add accessory expansion assembly 238 to vehicle 2 as an aftermarket accessory to increase the number of ports available for DC accessories 237.

Accessory expansion assembly 238 may be hardwired into vehicle 2 as a part of the DC drawing components 235. Accessory expansion assembly 238 may also be directly coupled to battery assembly 50, charger 75, or exportable power bank 250. In the present embodiment, each of DC accessories 237, AC accessories 231, and accessory expansion assembly 238 are communicably coupled to controller 55. Controller 55 is configured to control the power consumption of accessories coupled to vehicle 2, including each of DC accessory 237, AC accessory 231, and the accessory expansion assembly 238. In various embodiments, controller 55 is configured to control (i.e., send and/or receive communication signals) the current level, the voltage level, a powered on/off status, and/or a fault status of each of DC accessory 237, AC accessory 231, and accessory expansion assembly 238. Additional details regarding accessory control can be found in U.S. application Ser. No. 16/560,588, filed Sep. 4, 2019, published as US20200198467A1, titled “MANAGING RECREATIONAL VEHICLES AND ACCESSORIES,” attorney docket no. “PLR-15-26865.03P-US”, the entire disclosure of which is expressly incorporated herein by reference.

Vehicle 2 also includes a user interface 8 supported by the frame 10. User interface 8 includes a display 9 configured to display a plurality of screen layouts which may include various information, such as vehicle speed, suspension status, brake status, G-force information, steering angle, group information, geographic information, battery level, battery capacity, battery discharge rate, charge rate, charge mode, or other information. User interface 8 also includes a plurality of inputs 12. Inputs 12 may be a hard button, a soft button, a switch, a lever, a knob, or other type of input. Further, a communications unit 260 is communicably coupled to the user interface 8. Communications unit 260 may communicate over BLTE (Bluetooth Low Energy), WiFi, a cellular network, a vehicle-to-vehicle network, or another type of communication. Communications unit 260 is configured to receive data (e.g., information, instructions or the like) from a mobile device 261, a cellular network 262, a server 263, or a vehicle 264. In various embodiments, communications unit 260 and/or controller 55 are integral with user interface 8. Inputs 12 may be used to control a motor characteristic, alter a battery discharge rate, alter a battery charge rate, initiate communication, control an AC accessory 231, control a DC accessory 237 or alter another characteristic of vehicle 2. Inputs 12 may also be used to cycle through various screen layouts, select soft buttons on display 9, or adjust a volume of a speaker system, for example. Additional details regarding display 9 of vehicle 2 can be found in U.S. Pat. No. 9,324,195, filed Feb. 26, 2014, issued Apr. 26, 2016, titled “RECREATIONAL VEHICLE INTERACTIVE TELEMETRY, MAPPING, AND TRIP PLANNING SYSTEM”, attorney docket no. “PLR-15-25635.03P-US,” the entire disclosure of which is expressly incorporated herein by reference.

In the present embodiment, external battery, or accessory battery 236 may be a battery similar to battery 51 or may be another type of battery. External battery 236 may be a battery used in accessories such as a removable tool battery. In various embodiments, external battery 236 is a deep cycle battery commonly used in automotive vehicles, recreational vehicles, or other types of vehicles. External battery 236 may be electrically coupled to vehicle 2 at the accessory expansion assembly 238. In various embodiments, external battery 236 may be electrically coupled to vehicle 2 at charger 75. External battery 236 is electrically coupled to battery 51 when battery 51 is installed on vehicle 2 and external battery 236 is electrically coupled to vehicle 2.

Still referring to FIG. 3, vehicle 2 also includes a Global Positioning System (GPS), or location determiner, 56 configured to determine a geographical location of vehicle 2. In various embodiments, GPS 56 is integral with user interface 8. Further, vehicle 2 includes a telematics control unit (TCU) 270 operably coupled to controller 55. TCU 270 is configured to connect to a cloud network 271. Cloud network 271 may be accessible by a user of vehicle 2, another vehicle, a third party, the original equipment manufacturer (OEM) or another organization. Cloud network 271 may send instructions or information to vehicle 2 or may receive instructions or information from vehicle 2. Instructions or information may include fault codes, direction instructions, battery capacity information, battery discharge information, battery health information, motor health information, motor speed, motor temperature, battery temperature, charger information, or other vehicle information. Additional information regarding the use of telematics control unit 270 and vehicle connectivity can be found in U.S. application Ser. No. 17/506,249, filed Oct. 20, 2021, titled “VEHICLE COMMUNICATION AND MONITORING,” attorney docket no. “PLR-886-29463.03P-US”, the entire disclosure of which is expressly disclosed herein by reference.

### Battery Features and Connector

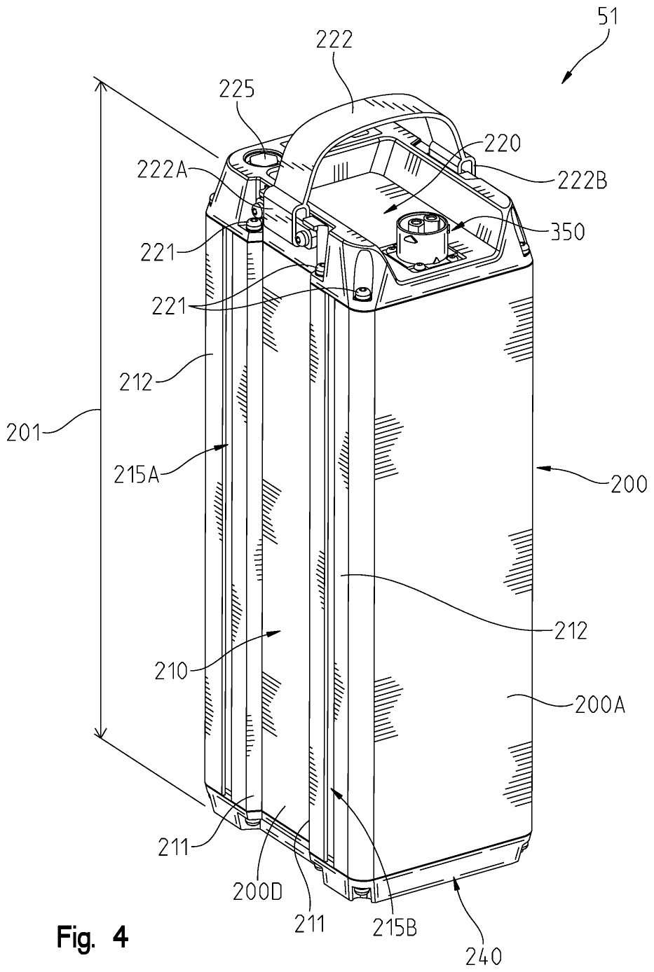

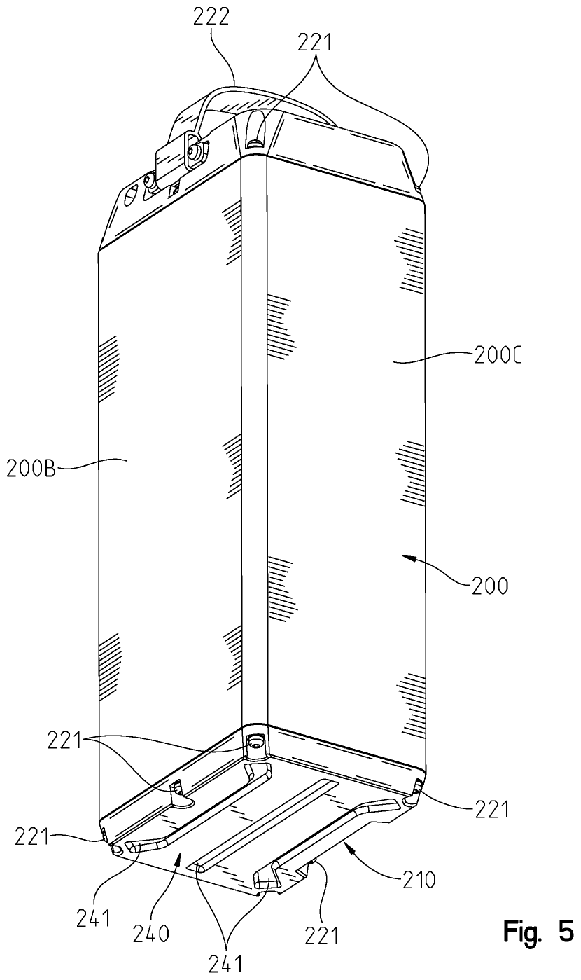

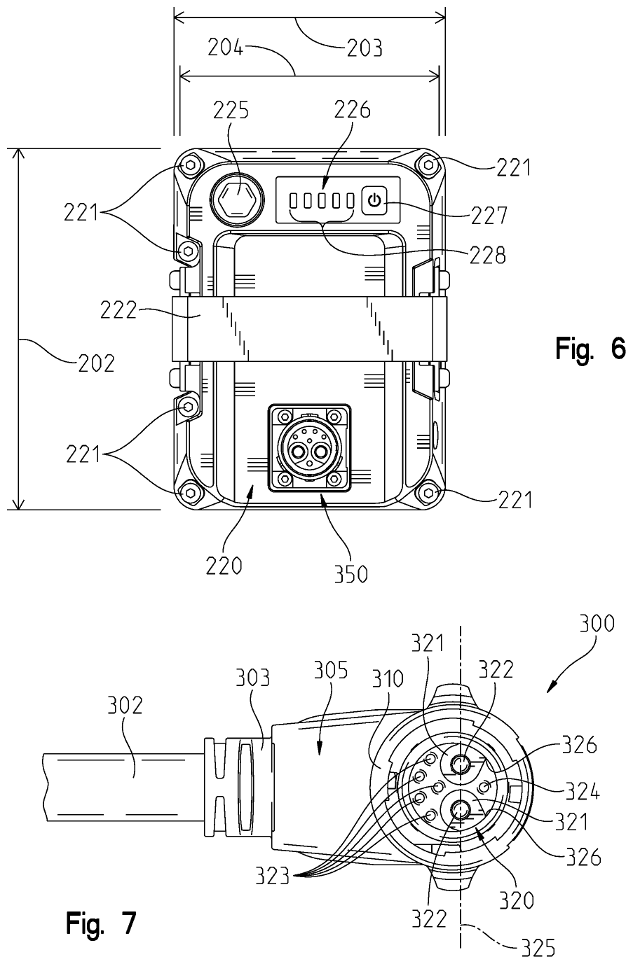

In the present embodiment, it is desirable to have a battery 51 that is lightweight, easily transportable, power dense, and user friendly. Now referring to FIGS. 4-6, battery 51 will be described in greater detail. Battery 51 is generally in the shape of a rectangular prism and configured to store electrical energy. Battery 51 includes a housing 200 with a first wall 200A, a second wall 200B, a third wall 200C, and a fourth wall 200D. Battery 51 includes a plurality of cells (not shown) configured to store and discharge electrical energy. The cells may be made of any suitable chemical composition sufficient to store energy and discharge energy for use by vehicle 2. Battery 51 may be a lithium-ion battery, an alkaline battery, a lead acid battery, a zinc carbon battery, a lithium cobalt battery, or other suitable battery chemistry. Housing 200 also includes a cover 220 and a base 240 each configured to couple to each of first wall or side 200A, second wall or side 200B, third wall or side 200C, and fourth wall or side 200D. First wall 200A and third wall 200C are positioned parallel to each other, and second wall 200B and fourth wall 200D extend between first wall 200A and third wall 200C. Each of cover 220 and base 240 are coupled to each of first wall 200A, second wall 200B, third wall 200C, and fourth wall 200D with a plurality of fasteners 221. Further, cover 220 and base 240 extend generally parallel to each other. In the present embodiment, one of the walls, namely fourth wall 200D, is configured with a plurality of features, which will be described in greater detail herein. Battery 51 has a height 201 extending in a first direction, a width 202 extending in a second direction, and a depth 203 extending in a third direction.

In the present embodiment, three of the walls, namely, first wall 200A, second wall 200B, and third wall 200C are configured as flat surfaces without features. In the present embodiment, fourth wall 200D includes a plurality of features including a first T-slot 215A, a second T-slot 215B, and a recessed portion 210. Illustratively, each of the first T-slot 215A, the second T-slot 215B and the recessed portion 210 extend the entire height of fourth wall 200D between cover 220 and base 240. T-slots 215 extend inwardly from an outer face 212 and may be used as a mounting point on battery 51. T-slots 215 may be used to mount badging, emblems, a separate cover, or other type of accessory to battery 51. A ramped portion 211 extends downwardly from outer face 212 to recessed portion 210. Illustratively, battery 51 has a depth 204 taken at the recessed portion 210. Illustratively, depth 204 is less than depth 203. Recessed portion 210 is configured as a poka-yoke feature or a registration feature. That is, recessed portion 210 may provide a registration feature for when battery 51 is placed into vehicle 2 so that battery 51 may only be placed within vehicle 2 in a single orientation, therefore, battery 51 may not be incorrectly placed within vehicle 2. A receiving volume (not shown) in vehicle 2 may have three flat surfaces corresponding to first wall 200A, second wall 200B, and third wall 200C and the receiving volume may have a fourth surface with a projection feature (not shown, congruent to recess 210) configured to receive fourth wall 200D. In the present embodiment, battery 51 may only be placed within the receiving volume in one orientation. In various embodiments, battery 51 may include a plurality of registration features that may be similar to recess 210.

Battery 51 is configured for easy insertion into and removal from vehicle 2. Vehicle 2 may be configured to hold a single battery, a pair of batteries, three batteries, or more batteries. Multiple batteries 51 may be electrically coupled in parallel or in series depending on the desired performance of vehicle 2. In one example, batteries 51 are configured in series to increase the overall voltage available to vehicle 2. In another example, batteries 51 are configured in parallel to increase the overall current available to vehicle 2.

Still referring to FIGS. 4-6, battery 51 includes a strap, or retention member 222 extending across cover 220. Strap 222 includes a first end 222A and a second end 222B. Strap 222 is coupled to cover 220 adjacent fourth wall 200D at first end 222A and further coupled to cover 220 adjacent second wall 200B at second end 222B. Strap 222 is generally aligned along a center of the width 202 of battery 51. In various embodiments, strap 222 comprises a rubber overmold handle positioned intermediate first end 222A and second end 222B. Battery 51 also includes a charge port 350 positioned on cover 220. Illustratively, charge port 350 is positioned on one side of strap 222 in the second direction. In various embodiments, charge port 350 may be located on any suitable location on battery 51, such as first wall 200A, second wall 200B, third wall 200C, fourth wall 200D, or base 240. In the present embodiment, charge port 350 is placed on cover 350 so that it is accessible to a user of the vehicle 2 when battery 51 is placed within vehicle 2. Battery 51 also includes a vent 225 positioned on cover 220. Vent 225 is configured to release gases within the housing 200. In various embodiments, when the gases in the housing 200 reach a certain pressure, vent 225 releases them to equalize and/or normalize pressure relative to an ambient pressure external to battery 51.

Battery 51 also includes a state of charge (SOC) indicator 226. In the present embodiment, SOC indicator 226 is positioned adjacent vent 225. SOC indicator 226 includes an input 227 and a plurality of indicator lights 228. In the present embodiment, indicator lights 228 are linearly aligned and each represent a portion of the battery charge level. In the present embodiment, SOC indicator 226 includes five indicator lights 228, each representative of 20% battery charge level. That is, if one indicator light 228 is turned on, battery 51 has 20% charge, if two indicator lights 228 are turned on, battery 51 has 40% charge, if three indicator lights 228 are turned on, battery 51 has 60% charge, if four indicator lights 228 are turned on, battery 51 has 80% charge, and if all five indicator lights 228 are turned on, battery 51 has 100% charge. In various embodiments, SOC indicator 226 may have fewer or more indicator lights 228. When a user desires to see a state of charge of battery 51, the user may press input 227 which will illuminate the appropriate number of indicators 228 to display the charge level of vehicle 2. In various embodiments, a user may press input 227 in a unique manner (e.g., long hold press or three presses in rapid succession) and SOC indicator 226 may display a unique arrangement of lights using indicators 228 which represent unique fault codes.

In the present embodiment, each of charge port 350, vent 225, strap 222 and SOC indicator 226 are positioned on cover 220 so that a user may easily access or view these features when battery 51 is inserted into vehicle 2. Additionally, each of exportable power bank 250, vent 225, strap 222, and indicator 226 may be placed so that they are easily accessible or viewable regardless of what type of vehicle battery 51 is placed in.

In various embodiments, battery 51 may be configured with a cover, or wrap (not shown), configured to cover, or conceal, at least a portion of battery 51. The wrap may be made of a flame retardant material. In the present embodiment, battery 51 comprises, generally, six sides, and the wrap may cover five sides of battery 51 and provide one open side to allow gases or fluids to exit out a desired direction in the event of a fault within vehicle 2 or battery 51. In the present embodiment, the open side is directed away from a user of the vehicle 2. In various embodiments, the wrap is configured to cover four sides, three sides, two sides, or only one side of battery 51. In the present embodiment, the wrap is constructed as a two-dimensional pattern (i.e., 2-D box template/pattern) and is wrapped around battery 51 and coupled together using hook and loop or other removable connectors. In various embodiments, the wrap is constructed as an open volume and the wrap is placed around battery 51. In various embodiments, the wrap is sewn together. In yet other embodiments, the wrap is coupled together using magnets, or clasps, or other fasteners.

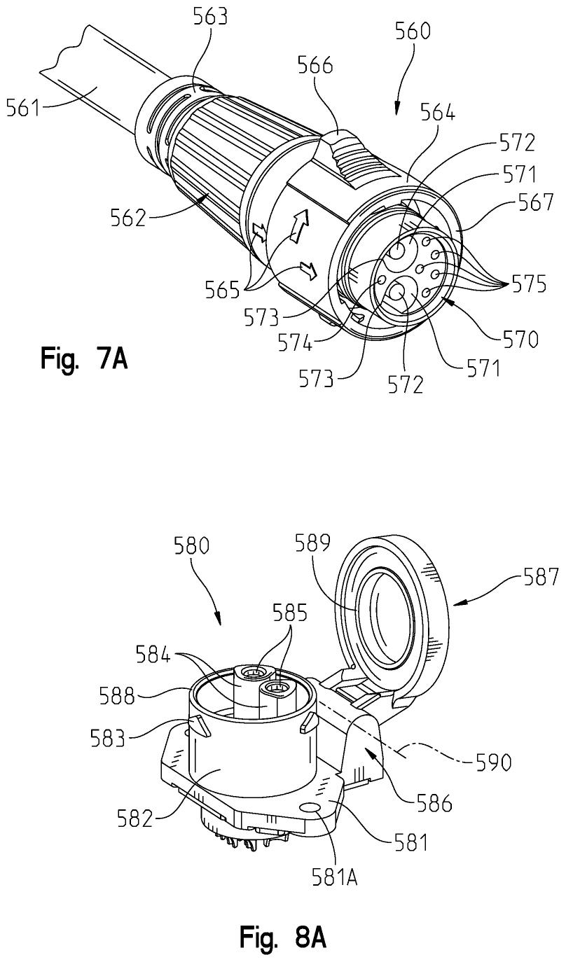

Now referring to FIGS. 7-10, it is desirable to have a robust connection solution to electrically couple together motor assembly 60, battery assembly 50, charger 75, and various sources 180, 185, 190. A connector should be able to transfer sufficient power, withstand a high number of connection cycles, and endure harsh conditions while still operating appropriately. In the present embodiment, charge port 350 on battery 51 is congruent with (i.e., able to mate with) a connecting pin pattern 320 of a connector 300. Connecting pin pattern 320 includes a pair of recessed volumes 321 each configured to house a primary voltage pin 322. Connecting pin pattern 320 also includes a ground pin receiver 324 and a plurality of accessory pin receivers 323. Illustratively, connecting pin pattern 320 is a 2+1+5 pattern.

In one embodiment, connector 300 is positioned intermediate any of generator 180, AC source 185, DC source 190 and charger 75. In another embodiment, connector 300 is positioned intermediate any of generator 180, AC source 185, DC source 190 and battery 51. In various embodiments, connector 300 is positioned intermediate charger 75 and battery 51. In the present embodiment, primary voltage pins 322 are configured to pass the high voltage power from the connector 350 to either charger 75 or directly to battery 51. One of the pair of primary voltage pins 322 is configured to pass a high voltage current to vehicle 2, and the other of the pair of primary voltage pins 322 is a neutral pin configured to provide a path back from vehicle 2. Ground pin receiver 324 is configured to provide a redundant safety connection in the event of a short-circuit event. Illustratively, ground pin receiver 324 is on one side of a line 325 intersecting the middle of each of primary voltage pin 322. Further, each of accessory pin receivers 323 are positioned on the other side of line 325 from ground pin receiver 324. Further, recessed volumes 321 are generally a teardrop shape with a primarily curved outer edge with a single pointed portion 326. Illustratively, pointed portion 326 is positioned on the same side of line 325 as ground pin receiver 324. Illustratively, charging port 350 is configured with an identically inverted shape to receive the connecting pin pattern 320.

Accessory pin receivers 323 are configured to provide a low voltage input to charger 75 or battery 51. Accessory pin receivers 323 are configured to transfer data, information, or instructions between generator 180, AC source 185, DC source 190, motor controller 62, 162 and charger 75 or battery 51. Accessory pin receivers 323 may be used to transfer information such as charge rate, battery capacity, battery charge, battery health, source health, source capacity, source identifier code, or other information. In various embodiments, pin 324 is also an accessory pin, and in yet other embodiments, any of accessory pins 323 may be used as the ground pin.

Connector 300 also includes a protection sleeve 302 configured to house the electrical wires/inputs to connector 300. Further, connector 300 includes a housing 305 and a support structure 303 positioned along protection sleeve 302, abutting housing 305, configured to support the protection sleeve 302 when connector 300 is bending or moving. Connector 300 also includes an outer protective flange 310 configured to protect the connecting pin pattern 320 from debris, liquid, or other intrusive materials.

In the present embodiment, the unique shape and orientation of connecting pin pattern 320 provides a unique connector for vehicle 2, and for charger 75 and battery 51. Connector 300 is configured only to work with vehicles 2, 101 or associated components and vehicles (not shown).

Referring now to FIG. 7A, an alternate connector 560 is shown. Connector 560 is coupled to an electrical wire 561 which extends into a housing 562. A protective sleeve 563 is coupled to housing 562 and extends over electrical wire 561 to protect wire 561 during bending. In the present embodiment, housing comprises a thumb support 566 configured to provide a leverage point for a user inserting and removing connector 560 from a plug-in spot/connection port. Housing 562 also comprises a plurality of directional arrows 565 configured to direct a user which way to plug-in and secure connector 560 within connection port 350. Housing 562 also comprises a sleeve 564 extending forward from housing 562 to surround a connecting pin pattern 570. Sleeve 564 extends forward and terminates at a lip 567.

Connector 560 also comprises a connecting pin pattern 570 that is the same as connecting pin pattern 320. That is, connecting pin patter 570 comprises a pair of recesses 571 in a generally teardrop shaped form with a pointed portion 573. A pair of primary voltage pins 572 are positioned within recesses 571. A plurality of accessor pin receivers 323 are positioned adjacent recesses 571 and a ground pin receiver 574 is positioned adjacent recesses 571.

In the present embodiment, connector 560 is a straight-line connector and connector 300 is a right-angle connector. Each connector 560, 300 is configured to be used in various scenarios based upon space available to a user.

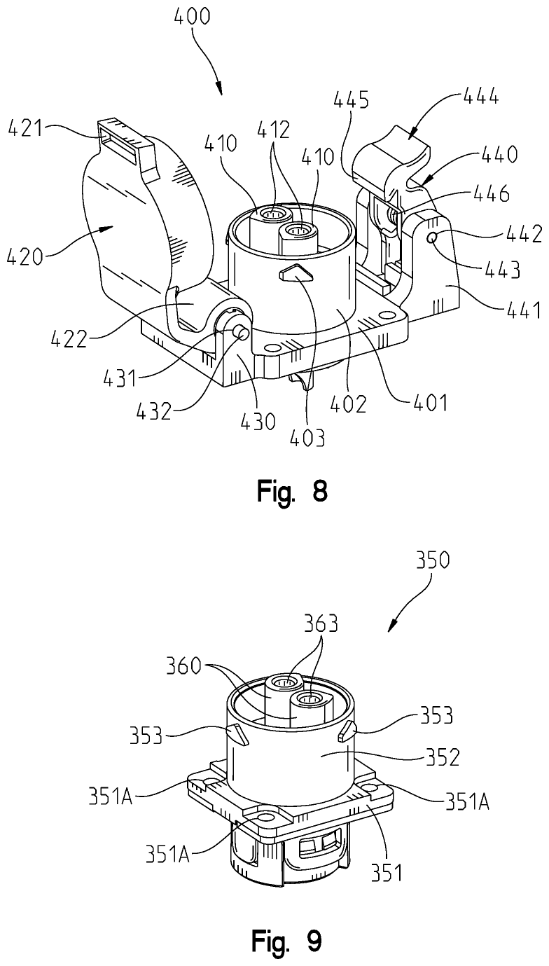

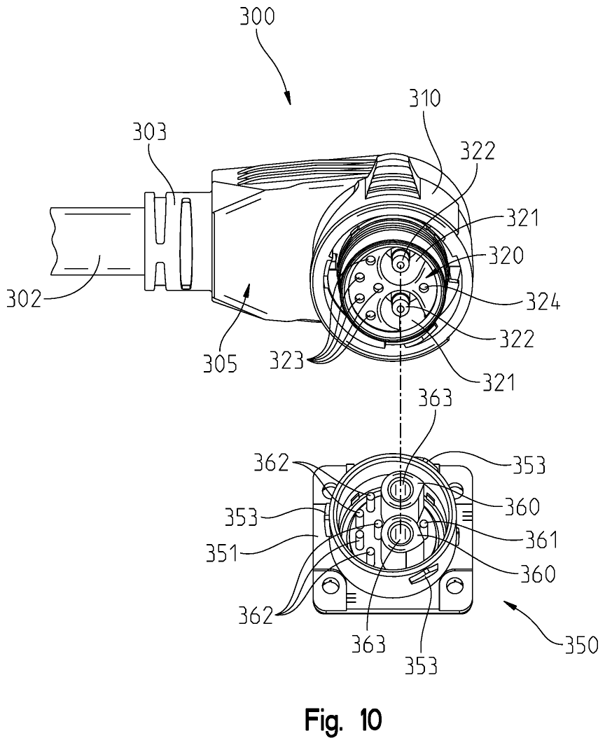

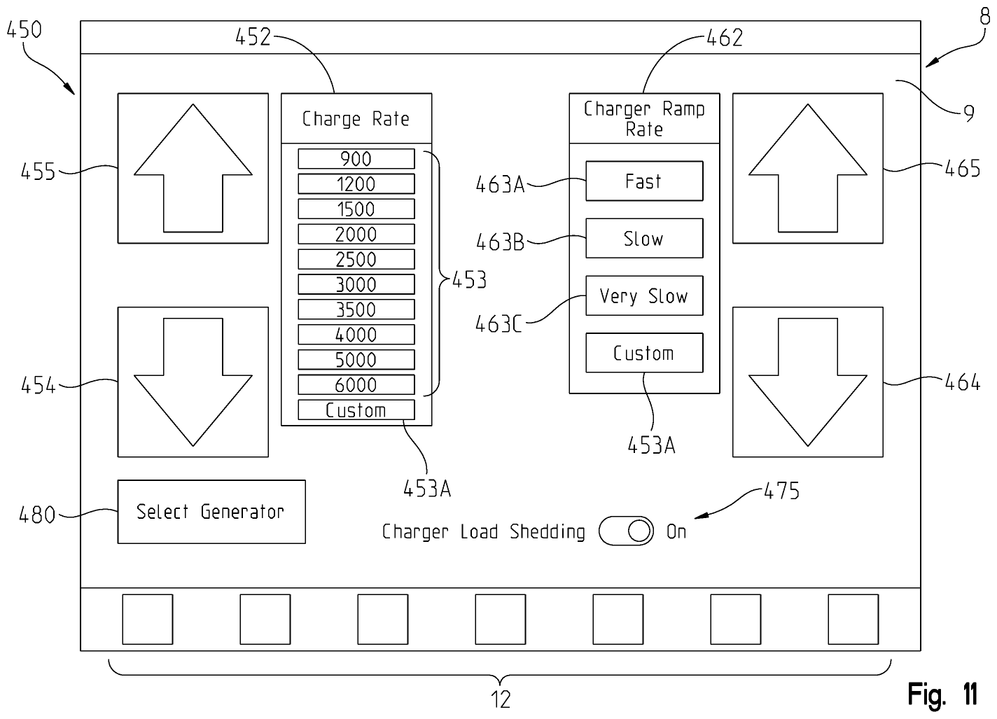

Referring now to FIG. 8-10, connection port 350 and a connection port 400 will be described in greater detail. Each of connection port 350 and connection port 400 are configured to mate, or couple, with connector 300 and connector 560 and transfer power and/or information therebetween. In the present embodiment, connection port 350 is configured to be physically coupled to battery 51, and connection port 400 is configured to be physically coupled to charger 75. Connection port 350 includes a base 351 with a plurality of apertures 351A configured to receive a fastener (not shown) to couple connection port 350 to battery 51. Connection port 350 also includes a circular flange 352 positioned at a center of base 351. Flange 352 includes a plurality of registration features 353 configured to interface with the outer protective flange 310. In the present embodiment, registration features 353 are positioned on an outer surface of flange 352. Connection port 350 also includes a pair of raised primary pin receivers 360 positioned within the interior of circular flange 352. Primary pin receivers 360 include a pair of apertures 363, and primary voltage pins 322 are configured to extend through apertures 363. As shown in FIG. 10, when connector 300 is aligned with connection port 350, connecting pin pattern 320 is configured to align with, and fit within, circular flange 352. Further, when properly aligned, primary voltage pins 322 are configured to align with, and fit within, apertures 363 and raised primary pin receivers 360 are configured to align with, and fit within, recessed volumes 321. Connection port 350 also includes a plurality of accessory pins 362 configured to fit within accessory pin receivers 323 and a ground pin 361 configured to fit with ground pin receiver 324.

Referring to FIG. 8, similar to connection port 350, connection port 400 includes a base 401 and a circular flange 402 positioned at a center of base 401. Circular flange 402 includes a plurality of registration features 403 positioned on an outer surface thereof configured to interface with the other protective flange 310. Connection port 400 further includes a pair of raised primary pin receivers 410 shaped and sized to fit within recessed volumes 321. Primary pin receivers 410 include a pair of apertures 412 and the primary voltage pins 322 are configured to extend through apertures 412. Connection port 400 also includes a plurality of accessory pins (not shown, similar to accessory pins 362) and a ground pin (not shown, similar to ground pin 361).

Base 401 includes a pair of arms 430 positioned on one extent thereof and adjacent to circular flange 402, and a second pair of arms 441 positioned on another extent thereof, opposite of arms 430. Arms 430 include an aperture 431 configured to receive a pin 432. Similarly, arms 441 include an aperture 442 configured to receive a pin 443. A cover 420 includes a pin housing 422 configured to receive pin 432. That is, cover 420 is configured to sit between arms 430 and rotate about pin 432 to either reveal or conceal circular flange 402. Cover 420 also includes a latch receiver 421 positioned on an extent of cover 420 opposite pin housing 422. Cover 420 is configured to protect flange 402, pin receivers 410 and pins (same as pins 361, 362) from debris, liquid, or other environmental conditions when connection port 400 is not in use. Connection port 400 also includes a latch 440 positioned intermediate arms 441. Latch 440 rotates about pin 443 between arms 441. Latch 440 also includes a latch engagement member 444 with a tip 445. Tip 445 is generally sized and shaped to engage latch receiver 421. In the present embodiment, a biasing member 446 is positioned around pin 443 and biases latch 444 in an engaged positioned with tip 445 rotated downward into engagement with latch receiver 421. In the present embodiment, biasing member 446 is a torsion spring. In various embodiments, biasing member 446 is another type of spring, a shock absorber, a linear force element, or other type of biasing member.

In the present embodiment, latch receiver 421 is generally rectangular. In various embodiments, latch receiver 421 may have a cross-sectional shape which is circular, square, oval, or otherwise shaped to receive tip 445. As shown in FIG. 8, connection port 400 displays cover 420 in an unengaged position, revealing flange 402 and each of the pins and pin receivers. A user may further rotate cover 420 downward to conceal flange 402 and each of the pins and pin receivers, and further allow latch 440 to rotate downward to allow tip 445 to engage latch receiver 421, thereby locking cover 420 in an engaged position.

Referring now to FIG. 8A, an alternate connection port 580 will be described. Connection port 580 comprises a base 581 with a plurality of apertures 581A. Base 581 supports a sleeve 582 extending upward from base 581. Sleeve 582 terminates in a lip 588 and comprises a plurality of registration features 583 configured to interface with connector 300, 560. Connection port 580 comprises a pair of primary pin receivers 584 positioned within sleeve 582. Primary pin receivers 584 comprise an aperture 585 configured to receive primary voltage pins 572. A plurality of accessory pins (not shown, similar to pins 362) and a ground pin (not shown, similar to pin 361) are also positioned within sleeve 582. That is, the plurality of pins positioned within sleeve 582 are configured to interface with connecting pin pattern 320, 570.

Connection port 580 also comprises an arm 586 coupled to base 581. Arm 586 supports cover 587 which is rotatably coupled to arm 586 about a cover rotation axis 590. In the present embodiment, a torsion spring is positioned within arm 586 to bias cover 587 in a closed position. In various embodiments, any suitable rotational member may be positioned within arm 586 to bias cover 587. Cover 587 comprises an internal recess 589 sized and shaped to receive lip 588. The interface between cover 587 and lip 588 creates a sealed interface, thereby sealing the plurality of pins positioned within sleeve 582. Cover 587 may be rotated into an open position to reveal the pins, and my be rotated into a closed position to conceal and seal the pins.

### Deployable Battery Charger

Referring again to FIG. 1, charger 75 may be removably coupled to vehicle 2. As previously described, charger 75 includes charging port 350 or charging port 400 to receive an electrical input from generator 180, AC source 185, or DC source 190. Charger 75 also includes an electrical output port (not shown) which is configured to output electricity to battery assembly 50. The electrical output port is configured to have a high connection life-cycle that is robust, and resistant to harsh conditions such as rain, snow, ice, and mud. In one embodiment, charger 75 is similarly sized and shaped to a storage container (not shown) and may be interchanged with a storage container when charger 75 is not coupled to vehicle 2.

In one example, a user of vehicle 2 completes a ride and desires to charge vehicle 2. A user attaches a power source generator 180, AC source 185, or DC source 190 to charger 75 and charges battery assembly 50. When the batteries 51 have been sufficiently charged, the user can remove the power source generator 180, AC source 185, DC source 190 from charger 75 and further remove charger 75 from vehicle 2. Charger 75 is typically heavy, large, and inconvenient, and a benefit is perceived in removing charger 75 from vehicle 2 when not in use. When charger 75 is removed from vehicle 2, a storage container, or other useful accessory, may be added to vehicle 2. In various embodiments, charger 75 may be replaced with an accessory mounting structure, a light/illumination structure/accessory, external battery 236, exportable power bank 250, AC accessory 231, DC accessory 237, expandable accessory ports 238, or other accessory or structure.

In various embodiments, charger 75 is coupled to vehicle 2 using an accessory mounting system, a fastener, or other mounting method. Charger 75 may be configured to automatically electrically couple to battery assembly 50 when charger 75 is coupled to vehicle 2 appropriately. In various embodiments, charger 75 is coupled to vehicle 2 using a Polaris Lock & Ride® system, sold by Polaris Industries Inc., Medina, Minnesota. Additional details regarding an accessory mounting system are found in U.S. Pat. No. 7,055,454, filed Jul. 13, 2004, issued Jun. 6, 2006, titled “VEHICLE EXPANSION RETAINER”, and U.S. Application No. 63/357,204, filed Jun. 30, 2022, titled “CARGO AREA FOR UTILITY VEHICLE”, attorney docket no. “PLR-04-29410.01P-US,” the entire disclosures of which are expressly incorporated herein by reference. In various embodiments, charger 75 may be mounted in place of, or on top of, a cargo rack for vehicle 2, 101. In various embodiments, charger 75 is mounted within a utility bed, under a utility bed, on a floorboard, under a seat, attached to the frame 10, or positioned in another spot in vehicle 2.

### Generator Control

Now referring to FIG. 11, vehicle 2 is configured to be operably coupled to generator 180. In one embodiment, generator 180 is configured to electrically couple to charger 75 to charge batteries 51 or otherwise provide power to power draw components 230. In various embodiments, generator 180 may provide an AC voltage or a DC voltage to vehicle 2. Generator 180 may have any suitable level of power production, as previously described.

Generators 180 have often been used to charge batteries, however, a common difficulty is matching the power draw signature of vehicle 2 and charger 75 to the power characteristics, available power, or generator capacity, of generator 180. In one example, charger 75 is configured to charge batteries 51 at a rate of 1200 W, and if generator 180 is rated at less than 1200 W, generator 180 may stall out as a result of attempting to provide more power than it is capable of providing. In another example, if generator 180 is rated to provide enough power to charger 75, a sudden high draw on generator 180 from charger 75 may result in generator 180 stalling out. As such, it is desirable to configure charger 75 to draw power from generator 180 at an appropriate rate and to increase the rate at an appropriate ramp rate.

As shown in FIG. 11, display 9 of user interface 8 includes a generator configuration screen layout 450 for configuring the interaction between charger 75 and generator 180. In the present embodiment charger 75 is operably coupled to controller 55, and controller 55 is operably coupled to user interface 8. As such, an input to user interface 8 may provide instructions to charger 75 through controller 55. In the present embodiment, controller 55 is configured to provide a plurality of charger data between user interface 8 and charger 75. Charger data may include a Max Power (W), or charge rate 452, a Charger Ramp Rate 462, a Load Shedding Flag 475, type of generator 180, the amount of power needed at battery 51 and other data.

As shown in FIG. 11, charge rate 452 may be set at any one of a plurality of preset, discrete values 453. In the present embodiment, charge rate 452 may be 900 W, 1200 W, 1500 W, 2000 W, 2500 W, 3000 W, 3500 W, 4000 W, 5000 W, or 6000 W. In various embodiments, a custom option 453A may be provided which allows a user to input another discrete value corresponding to a desired charge rate 452. Screen layout 450 also includes an increasing value indicator 455, such as an up arrow, and a decreasing value indicator 454, such as a down arrow. In the present embodiment, the user may select value indicators 454, 455 to toggle through the discrete values 453 provided on screen layout 450. In another embodiment, if the user selects the custom charge rate option 453A, the user may select value indicators 454, 455 to toggle the value of charge rate 452 to reach the desired value. In the present embodiment, when a user selects a desired charge rate 452, user interface 8 sends instructions, via controller 55, to charger 75 to limit charging to generator 180 to the desired charge rate 452. In one embodiment, a user will alter the charging rate 452 to be a value at or below the rated power generation capacity of generator 180 to not stall generator 180 by attempting to pull too much power from generator 180. In another embodiment, a user may be aware that the generator 180 is also charging/powering another accessory (e.g., lights), and the user chooses a charging rate 452 that allows generator 180 to provide power to charger 75 and the other accessory without stalling generator 180.

Charger ramp rate 462 is indicative of a rate that the charger 75 will ramp up the charging rate 452 from OW to the desired charge rate 452. In the present embodiment, screen layout 450 provides three preset options 463, including a ‘Fast’ option 463A, ‘Normal’ option 463B, and ‘Slow’ option 463C for the charger ramp rate 462. In various embodiments, screen layout 450 includes a custom charger ramp rate option 463D configured to give the user more control over the ramp rate 462. Screen layout 450 also includes an increasing value indicator 465, such as an up arrow, and a decreasing value indicator 464, such as a down arrow. In the present embodiment, the user may select the value indicators 464, 465 to toggle through the preset charger ramp rate options 463 provided on screen layout 450. In another embodiment, if the user selects the custom charger rate option 463D, the user may select value indicators 464, 465 to toggle the value of charger ramp rate 462 to reach the desired value. In the present embodiment, when a user selects a desired charger ramp rate 462, user interface 8 sends instructions, via controller 55, to charger 75 to prescribe the charging ramp rate 462 between generator 180 and charger 75.

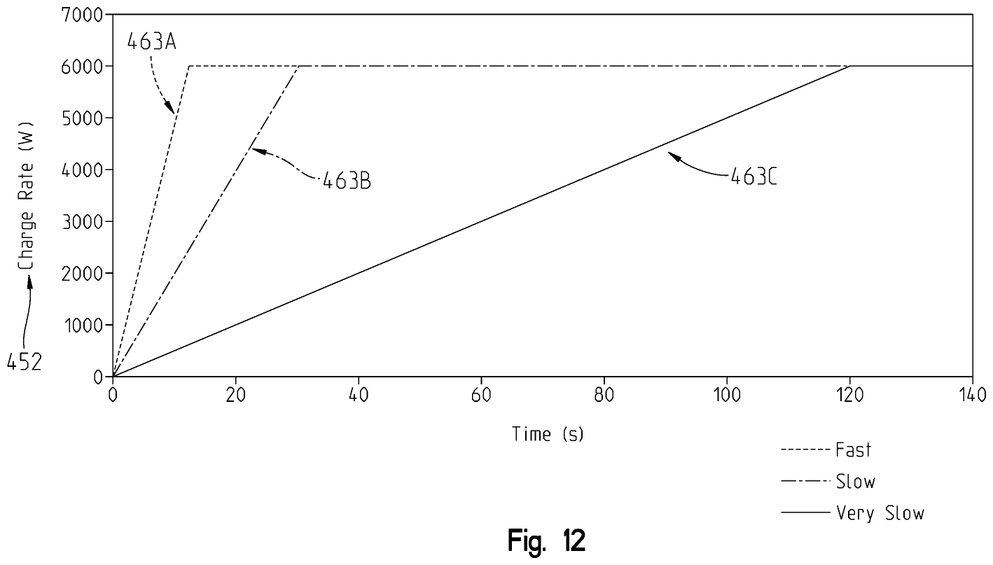

Now referring to FIG. 12, a graph is shown providing an example charger ramp rate 462 between generator 180 and charger 75. Illustratively, graph 470 includes a charger ramp rate 462 for the ‘Fast’ 463A, ‘Normal’ 463B, and ‘Slow’ 463C options up to a charge rate 452 of 6000 W. In the present embodiment, in the ‘Fast’ 463A charger ramp rate mode, the charger ramp rate 452 is greater than in the ‘Slow’ 463C or ‘Normal’ 463B mode. Further, in the ‘Normal’ 463B mode, charger 75 reaches the max charger rate 452 faster than the ‘Slow’ 463C option. In the present embodiment, the ‘Fast’ 463A option has a charger ramp rate of 500 W/s, the ‘Normal’ 463B option has a charger ramp rate of 200 W/s, and the ‘Slow’ option has a charger ramp rate of 50 W/s. In various embodiments, other charger ramp rates are contemplated.

Having a variable charger ramp rate 462 allows a user to adjust the pace at which charger 75 is increasing its power draw on generator 180. In some instances, if charger 75 initiates a max charge rate 452 instantaneously, the quick power draw can cause problems with generator 180, can be harsh on components of generator 180, and can cause generator 180 to stall. By initiating a charger ramp rate 462, the user is able to pull power at an increasing rate from generator 180, up to the max charge rate 452, while decreasing the stress on generator 180 and avoiding imparting high pulse loads on generator 180, thereby mitigating stall outs and increasing the life of generator 180.

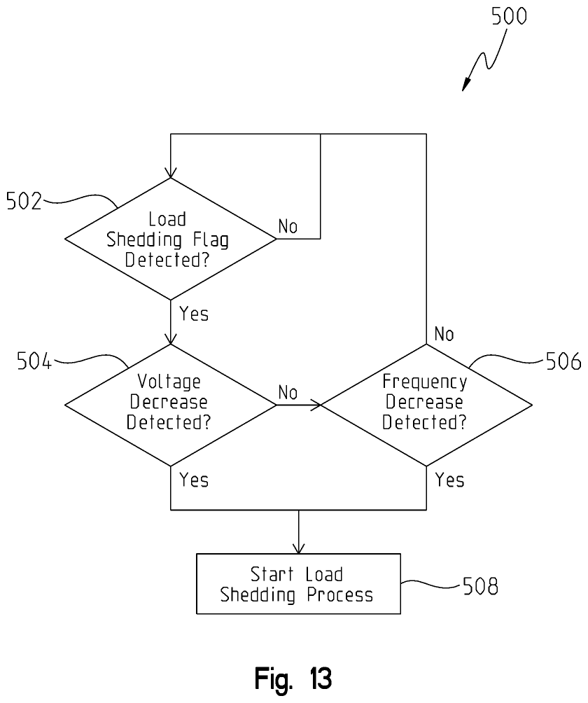

Referring again to FIG. 11, screen layout 450 includes a load shedding input 475. Load shedding input 475 is configured as a toggle button indicating the state of the load shedding feature of vehicle 2, 101, for example an ON or first state or an OFF or second state. Turning to FIG. 13, a process 500 will be explained, starting with decision block 502. Process 500 asks if the load shedding input 475 is in an ON state or OFF state. If the load shedding input 475 is in an OFF state, decision block 502 continuously repeats itself until it is determined that load shedding input 475 is in an ON state. When load shedding input 475 is in an ON state, user interface 8 sends, via controller 55, a load shedding flag, or indicator, to charger 75. When charger 75 receives the load shedding flag, process 500 moves to block 504 and charger 75 monitors an energy input from generator 180. Charger 75 is configured to monitor a voltage output, a current output, and a frequency output. In block 504, charger 75 is configured to determine if a voltage from the generator 180 has decreased. In various embodiments, block 504 is configured to determine if input voltage to the charger has decreased by a certain threshold, which may be a discrete value, a percentage of voltage, or another metric. In various embodiments, block 504 is configured to determine if the input voltage to the charger has decreased to a value lower than a minimum threshold. If it is determined that voltage has not decreased past the threshold in block 504, process 500 moves to block 506. Decision block 506 determines if the frequency of the input power has decreased. In various embodiments, block 506 is configured to determine if the frequency of the input power has decreased by a certain threshold, which may be a discrete value, a percentage of frequency, or another metric. In other embodiments, block 506 is configured to determine if the frequency of the input power has decreased to a value lower than a minimum threshold. If it is determined that frequency has not decreased past the threshold in block 506, process 500 moves back to the start of the process.

If it is determined that, in either block 504 or block 506, the voltage or frequency has fallen below a threshold, or other value, process 500 moves to block 508 where charger 75 will start the load shedding process. When it is determined that a voltage or frequency of the input power coming from generator 180 is dropping below a threshold, or other value, this may be indicative that generator 180 cannot keep up with the requested power. As such, it is beneficial to institute a load shedding process, where charger 75 may request less power so that the demand on generator 180 is decreased. This process will decrease the likelihood that generator 180 will experience a stalling event or other loss of power event. Load shedding in block 508 will instruct charger 75 to request a lower amount of overall power from generator 180 until voltage and frequency, in blocks 504 and 506, respectively, return to a state higher than the previously described thresholds. In various embodiments, in the load shedding process of block 508, charger 75 is configured to decrease the requested power input by a percentage of the total power requested. In yet other embodiments, charger 75 is configured to decrease the requested power input linearly until voltage and frequency return to value at or above the previously described thresholds. In one embodiment, if generator 180 is charging vehicle 2 and a user electrically couples an additional accessory to generator 180, the overall capacity of generator 180 is reduced, and when controller 55 instructs charger 75 to complete load shedding, charger 75 will decrease the requested power from generator 180 to better match the available power from generator 180.

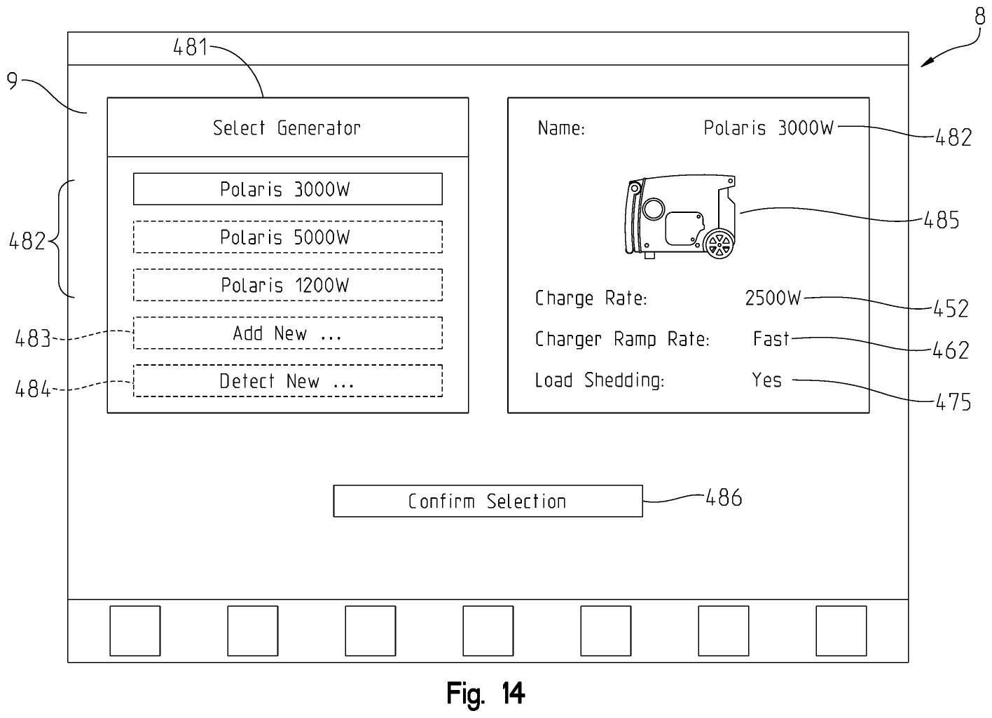

Referring again to FIG. 11, screen layout 450 includes an input 480 configured to allow a user to select a generator from a list of generators 481 (FIG. 13). As shown in FIG. 13, screen layout 478 displays the list of generators 481, which includes a plurality of selectable generators 482 that have been previously used with vehicle 2. In various embodiments, list of generators 481 is populated by mobile device 261, cellular network 262, server 263, or vehicle 264. As shown in FIG. 14, the first generator 180, ‘Polaris 3000 W’ is selected, and each selectable generator 482 has a profile 490 which may be displayed alongside list of generators 481 on screen layout 478. Profile 490 includes the selected generator 482, an image of the generator 185, a default charge rate 452, a default charger ramp rate 462, and a default load shedding flag state 275. In various embodiments, a user may select any aspect of the profile 490, including image 485, default charge rate 452, default charger ramp rate 462, and default load shedding state 475, and change the value associated with each of them similar to methods disclosed in reference to screen layout 450 in FIG. 11.

In the present embodiment, list 481 also includes a new generator option 483 configured to allow a user to add a new generator. When a user selects the new generator option 483, the user may name the generator, indicate a desired charge rate 452, a desired charger ramp rate 462, and a desired default load shedding flag state 275. List 481 may also include a detection option 484 configured to detect nearby generators. Detection option 484 may use the communications unit 260 to communicate via BLTE, WiFi, Cellular, or other method with a nearby generator 180. In another embodiment, a user may place a connected mobile device 261 nearby a compatible generator 180 so that mobile device 261 can read/receive the unique signature of generator 180 from an NFC chip. Additional details of various detection options may be found in PCT Application No. PCT/US2022/038442, filed Jul. 27, 2022, titled “VEHICLE SMART TAG”, attorney docket no. “PLR-OOTC-29872.02P-WO,” the entire disclosure of which is expressly incorporated herein by reference. Each of these methods provide a method for controller 55 to receive pertinent power information from generator 180, including charge rate 452, charger ramp rate 462, and load shedding flag 275. When controller 55 receives power information from the detected generator 180, profile 490 for the detected generator 180 is automatically populated. Illustratively, screen layout 450 includes a confirmation input 486 which may be selected when the correct generator 180 from list 481 is selected. When the confirmation input 486 is selected, controller 55 sends instructions to charger 75 to operate using the prescribed charge rate 452, charger ramp rate 462 and load shedding setting 475 for the profile 490 of selected generator 180.

In various embodiments, controller 55 determines that vehicle 2 is at a specified location by location determiner 56 and adjusts a generator setting based upon the location of vehicle 2. In one example, controller 55 uses GPS 56 or TCU 270 to determine vehicle 2 is at a ‘Home’ station, and is likely plugged into a constant power source, like a wall outlet, and will automatically disengage load shedding flag 475 because the power source is constant.

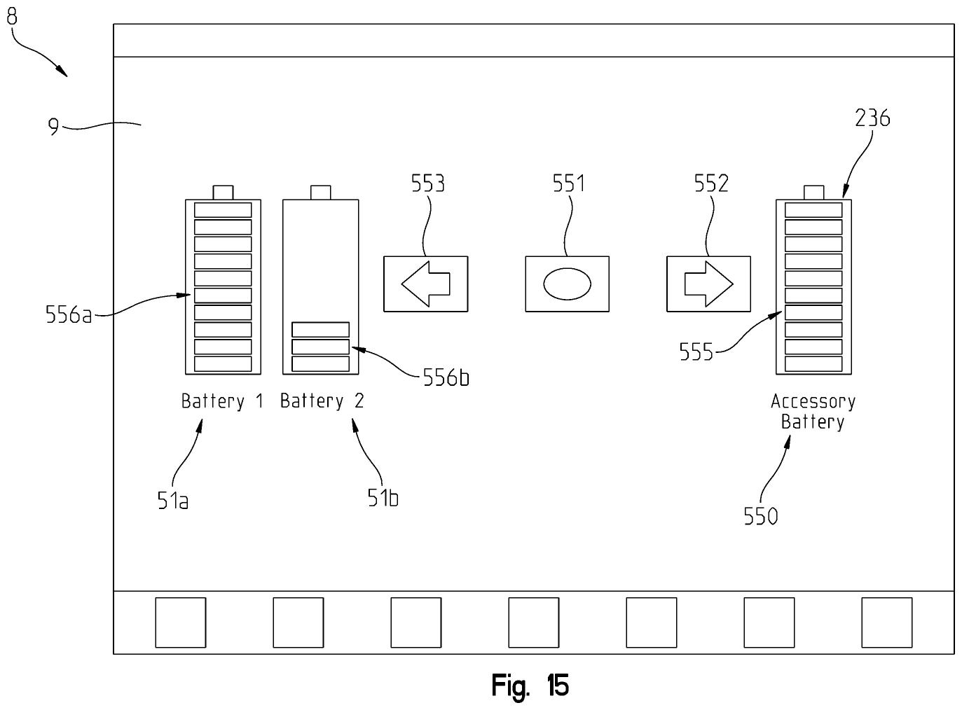

Now referring to FIG. 15, controller 55 is configured to detect when external battery 236 is electrically coupled to vehicle 2. In various embodiments, when external battery 236 is coupled to vehicle 2, controller 55 is configured to provide instructions to automatically charge external battery 236 using battery 51. In various embodiments, when external battery 236 is coupled to vehicle 2, controller 55 is configured to provide instructions to automatically charge battery 51 using external battery 236.

Still referring to FIG. 15, display 9 of user interface may include a screen layout 550 configured to display icons of batteries 51a and 51b and external battery 236. Further, screen layout 550 is configured to display the charge level 556 of batteries 51a, 51b and the charge level 555 of external battery 236. Screen layout 550 also includes a first directional input 552, a second directional input 553 and a neutral input 551. A user may actuate or select first directional input 552—illustratively, an arrow pointing from batteries 51a, 51b to external battery 236—and controller 55 is configured to provide instructions for batteries 51a, 51b to charge external batteries 236. Further, a user may actuate or select second directional input 553—illustratively, an arrow pointing from external battery 236 to batteries 51a, 51b—and controller 55 is configured to provide instructions for external battery 236 to charge batteries 51a, 51b. A user may actuate or select neutral input 551 in the event that the user does not want any electrical charge to be transferred either way between batteries 51 and external battery 236. When external battery 236 is coupled to vehicle 2, the connection between external battery 236 and batteries 51a, 51b is bidirectional.

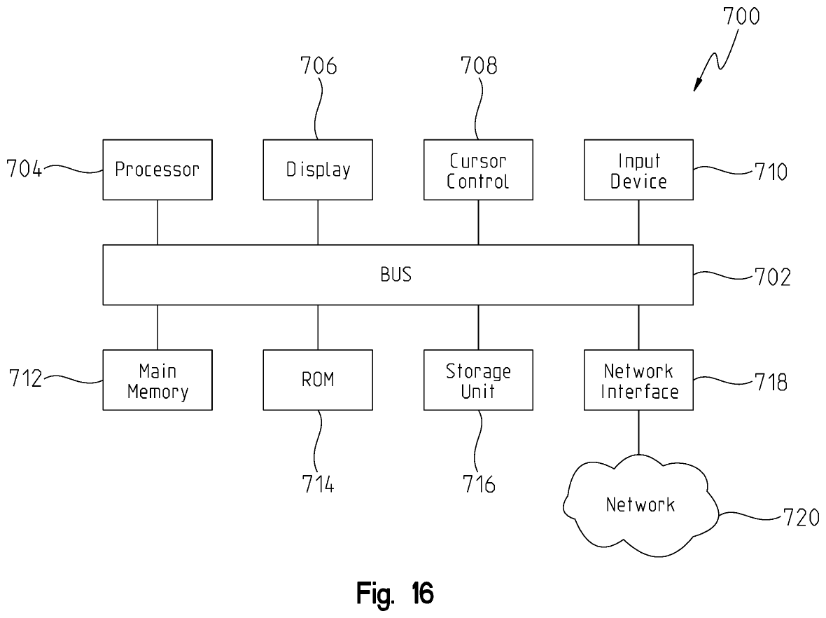

Referring now to FIG. 16, an exemplary computing system 700 is provided. In the present embodiment, some or all of the functions of controller 55, TCU 270, communications unit 260, mobile device 261, vehicle 264, user interface 8, or other systems on vehicles 2, 101 may be performed by one or more computing systems that has similar components as the computing system 700. This diagram is merely an example, which should not unduly limit the scope of the claims. One of ordinary skill in the art would recognize many variations, alternatives, and modifications.

The computing system 700 includes a bus 702 or other communication mechanism for communicating information between, a processor 704, a display 706, a cursor control component 708, an input device 710, a main memory 712, a read only memory (ROM) 714, a storage unit 716, and/or a network interface 718. In some examples, the bus 702 is coupled to the processor 704, the display 706, the cursor control component 708, the input device 710, the main memory 712, the read only memory (ROM) 714, the storage unit 716, and/or the network interface 718. And, in certain examples, the network interface 718 is coupled to a network 720 (e.g., the network 112).

In some examples, the processor 704 includes one or more general purpose microprocessors. In some examples, the main memory 712 (e.g., random access memory (RAM), cache and/or other dynamic storage devices) is configured to store information and instructions to be executed by the processor 704. In certain examples, the main memory 712 is configured to store temporary variables or other intermediate information during execution of instructions to be executed by processor 704. For example, the instructions, when stored in the storage unit 716 accessible to processor 704, render the computing system 700 into a special-purpose machine that is customized to perform the operations specified in the instructions (e.g., the components 112-128). In some examples, the ROM 714 is configured to store static information and instructions for the processor 704. In certain examples, the storage unit 716 (e.g., a magnetic disk, optical disk, or flash drive) is configured to store information and instructions.

Thus, computing system 700 may include at least some form of computer readable media. The computer readable media may be any available media that can be accessed by processor 704 or other devices. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may not include communication media.

In some embodiments, the display 706 (e.g., a cathode ray tube (CRT), an LCD display, or a touch screen) is configured to display information to a user of the computing system 700. In some examples, the input device 710 (e.g., alphanumeric and other keys) is configured to communicate information and commands to the processor 704. For example, the cursor control 708 (e.g., a mouse, a trackball, or cursor direction keys) is configured to communicate additional information and commands (e.g., to control cursor movements on the display 706) to the processor 704.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A utility vehicle, comprising:
a pair of front ground engaging members;
a pair of rear ground engaging members;
a frame supported by the ground engaging members;
a user interface supported by the frame, the user interface configured to receive a user input;
an electric motor supported by the frame;
a battery removably coupled to the frame, the battery electrically coupled to the electric motor;
a charger removably coupled to the frame, the charger configured to be electrically coupled to the battery; and
an electronic controller communicably coupled to the user interface and the charger;
a memory storing a set of instructions, the controller configured to operate the charger according to the first set of instructions based upon the user input at the user interface.

2. The utility vehicle of claim 1, wherein the set of instructions includes a charger operating characteristic, and the charger operating characteristic is one of a maximum charge rate and a charger ramp rate.

3. The utility vehicle of claim 2, wherein the charger is configured to be electrically coupled to an external power source, the controller is configured to receive a power characteristic from the external power source, the controller is further configured to alter the charger operating characteristic based on the power characteristic.

4. The utility vehicle of claim 1, further comprising an accessory power supply removably coupled from the vehicle, the accessory power supply is further configured to supply both AC power and DC power.

5. The utility vehicle of claim 2, wherein the charger is configured to couple to a generator, the generator is configured to provide an input power with an input voltage and an input frequency, and the set of instructions includes a load shedding flag configured to have a first status and a second status, the controller is configured to monitor at least one of the input voltage and the input frequency and alter a charger operating characteristic based upon the load shedding flag having the first status and at least one of the input voltage or input frequency decreasing below a threshold.

6. The utility vehicle of claim 2, wherein the charger is configured to couple to a generator, the generator is configured to provide an input power with an input voltage and an input frequency, and the set of instructions including a load shedding flag configured to have a first status and a second status, the controller is configured to monitor at least one of the input voltage and the input frequency and the controller is further configured to alter a charger operating characteristic based upon the load shedding flag having the first status and at least one of the input voltage or input frequency decreasing by a threshold amount.

7. The utility vehicle of claim 2, wherein the controller is configured to receive a location of the vehicle from a location determiner, the controller is further configured to alter a charger operating characteristic based upon the location of the vehicle.

8. The utility vehicle of claim 1, further comprising an accessory expansion assembly separably coupled to the vehicle, the accessory expansion assembly is electrically coupled to the battery assembly and configured to provide DC power to a plurality of accessories.

9. A utility vehicle, comprising:
a plurality of ground engaging members,
a frame supporting the plurality of ground engaging members;
an operator area supported by the frame, and a seat positioned within the operator area; and
a powertrain, comprising:
a motor supported by the frame, the motor configured to provide power to at least one of the plurality of ground engaging members;
a battery supported by the frame, the battery electrically coupled to the motor;
a charger electrically coupled to the battery, the charger having a charging input and being configured to operate with a charging characteristic, the charging input configured to receive a power input from an external power source;
a controller being operable to alter the charging characteristic of the charger;
a memory storing instructions that, when executed by the controller, cause the controller to:
receive a power characteristic from the external power source based upon the power input;
determine an operating charging characteristic based upon the power characteristic; and
operate the charger with the operating charging characteristic.

10. The utility vehicle of claim 9, wherein the operating charging characteristic is one of a maximum charge rate and a charging ramp rate.

11. The utility vehicle of claim 10, wherein the charging ramp rate is operable in a plurality of modes.

12. The utility vehicle of claim 9, further comprising a user interface, the user interface further includes a screen layout configured with a first input configured to alter a maximum charge rate and a second input configured to alter a charging ramp rate.

13. A utility vehicle, comprising:
a plurality of ground engaging members,
a frame supporting the plurality of ground engaging members;
an operator area supported by the frame, and a seat positioned within the operator area;
a user interface configured with an input; and
a powertrain, comprising:
a motor supported by the frame, the motor configured to provide power to at least one of the plurality of ground engaging members;
a battery supported by the frame, the battery electrically coupled to the motor;
a charger electrically coupled to the battery, the charger having a charging input and configured to operate with a charging characteristic, the charging input configured to receive a power input from an external power source; and
a controller being operable to alter the charging characteristic of the charger;
a memory storing instructions that, when executed by the controller, cause the controller to:
receive a user input from the user interface;
determine an operating charging characteristic based upon the user input;
operate the charger with the operating charging characteristic.

14. The utility vehicle of claim 13, wherein the operating charging characteristic is one of a maximum charge rate and a charging ramp rate.

15. The utility vehicle of claim 14, wherein the charging ramp rate is operable in a plurality of modes.

16. The utility vehicle of claim 13, wherein the user interface further includes a screen layout configured with a first input configured to alter a maximum charge rate and a second input configured to alter a charging ramp rate.
